(19) United States
(12) Patent Application Publication
(10) Pub. No.: US 2005/0202210 A1
(43) Pub. Date: Sep. 15, 2005

(54) Injection molding method, injection molding tool and object produced

(76) Inventor: Andre Schulthess, Toffen (CH)

Correspondence Address: YOUNG & THOMPSON, 745 SOUTH 23RD STREET, 2ND FLOOR, ARLINGTON, VA, 22202, US

(21) Appl. No.: 10/798,953

(22) Filed: Mar. 12, 2004

(51) Int. Cl. B32B 3/10; B32B 3/00

(52) U.S. Cl. 428/156; 428/131

(57) ABSTRACT

Areas of reduced (32) wall thickness down to a few hundredths of a millimeter are produced by injection molding, by means of a core (5) which is moved in the cavity (2) of an injection molding tool (1) when the molding mass almost completely fills the cavity (2), yet has not solidified. By this method, low cost hangers for dosimeters (20) may be produced integrally provided with a radiation transparent window.

### BACKGROUND OF THE INVENTION

The present invention relates to a method for injection molding of thermoplastic polymers. Furthermore, it also relates to an injection molding tool and objects produced by such injection molding tools processes.

Injection molding is a well-known method for producing products of polymeric material in numbers. However, known technology restricts minimum wall-thickness to about 0.15 mm. Thinner areas cannot be obtained with uniform density and thickness.

If the cavity (forming area) of an injection molding tool is designed to provide for a thinner area, experiments have shown that it is impossible to fill the created narrow gap reliably with a closed, uniform film. The flow of the molten mass enters from the periphery of the thin-walled area and unavoidably encloses an air or gas bubble which cannot evade or be evacuated, if the thin-walled area may not be disfigured with a (thick-walled) vent zone. Finally, the bubble remains close to the center of the thin-walled area, and either a perforation or at least a nonuniform and weakened spot remains.

An example of a product having such a thin area is a casing, housing or as it is professionally called, a dosimeter-hanger (henceforth called hanger) for personal, ambient or other solid-state, like Thermo Luminescence or optically Stimulated Luminescence dosimeters. Such dosimeters use areas of specific materials, having discriminating sensitivities to various kinds and qualities of ionizing radiation. At least one part or area of those materials must be kept virtually free of any kind of shielding or covering, which would absorb the radiation and therefore falsify a measurement. On the other hand, the dosimeters require a protective hanger to allow their being worn outside peoples clothing or being placed in the outdoors environment and exposed to the elements.

For the reasons mentioned above, the hanger is provided with a thin-walled window, where the wall-thickness of the hanger is made as thin as possible. Furthermore, the hanger must be waterproof and should allow labeling on the exterior surfaces. Labels are required in the field, to assign the dosimeter unmistakably to an individual person.

The known hangers consist of a base and a removable cover. They are separate pieces, in some cases connected by a hinge. Waterproofing is attained with an elastic sealing ring, placed in circumferential groove. The window is an opening in the cover, behind which a cut section of thin plastic film is fixed in place with adhesive.

Obviously, such hangers are rather expensive and are therefore designed for multiple use. Due to the need of reuse, the hangers can be reopened and the dosimeters, after their regular wear term, are exchanged by the users and not by the dosimetry laboratory, incurring the risk of the dosimeters being mistakenly assigned to the wrong person or even intentionally exchanged in cases of misuse. Furthermore, the plastic film, specifically after several wear cycles, is often mechanically damaged and/or the adhesive has lost its properties and waterproofing is compromised.

### SUMMARY OF THE INVENTION

It is an object of the invention to describe a method by which thin-walled areas can be produced by injection molding. To this end, the method comprises the steps of injecting the molding mass into the cavity of an injection molding tool and of pushing a shaped core into the cavity while the molding mass is still in its plastic state and hence capable to flow.

Another object of the invention is to offer a tool for performing the method. This injection molding tool comprises at least one core, circumferentially shaped to resemble the thin-walled area, the core being movable into the cavity of the tool to a defined position, where between the front face of the core and an opposing wall or the front face of another core, a gap of very small width is obtained.

Still another object of the present invention is to present an object produced by injection molding. Such an object is provided with at least one area of substantial extension (surface area) where the wall thickness is less than or equal to 0.1 mm. This thin-walled area of reduced thickness constitutes an integral part and consists of the same thermoplastic polymer material of the injection molded object.

A further object of the invention is to provide a hanger for personal dosimetry, which excludes the risk of unwarranted and nonrecorded exchange of the dosimeter it contains. Such a hanger provides for virtually unrestricted by absorption irradiation, through a thin section of the hanger, of the relevant areas of the contained dosimeter(s) and essentially consists of polymeric material. The thin section or window comprises an area of reduced thickness, integrally formed within the surrounding portion of the housing. The thickness of the window is less than or equal to 0.1 mm.

### BRIEF DESCRIPTION OF THE DRAWINGS

The invention will now be further explained in detail, by means of preferred execution examples with reference to the figures given.

FIG. 1 Partial section through an injection molding tool, with a movable shaped core, core withdrawn.

FIG. 2 Like FIG. 1, core in working position.

FIG. 3 Oblique top view on opened dosimeter hanger.

FIG. 4 Oblique bottom view on opened dosimeter hanger.

FIG. 5 View on closed dosimeter hanger.

FIG. 6 Top view on a dosimeter hanger, with inner (invisible) features, shown by dashed lines.

FIG. 7 Longitudinal vertical section according to line VII-VII in FIG. 6.

FIG. 8 Enlarged detail of FIG. 7 according to circle VIII in FIG. 7.

### DETAILED DESCRIPTION OF THE INVENTION

Generally, the area of reduced material thickness is obtained by creating the respective narrow mold area during the injection process. More specifically, when the cavity of the injection molding tool is sufficiently filled with the still fluid (plastic state) molding mass, a core is pushed in by mechanical, pneumatic or hydraulic force and reduces the width in the desired area within the cavity. Due to the closed and uniform layer of molding mass formed previous to moving the core forward, which presses the excess material out of the diminishing space, a perfect thin layer of molding mass is obtained in the residual gap between the front-face of the core and the opposing surface of the injection molding cavity. As the moulding mass is still fluid, the material displaced by the core can yield into the surrounding cavity.

By this method, inter alia a one-piece hanger can be produced, using a polymeric material by injection molding. The required window is constituted by an area of reduced thickness of 0.1 mm or less. It may present a thickness down to 0.02 mm, possibly even less, preferably, however, not less than 0.03 mm. An injection molding tool for executing the method comprises at least one movable core. An actuator for moving it in and out of the mould is present, as well as a control unit which is capable to activate the actuator when the cavity is about to be completely filled and the molding mass still in plastic state.

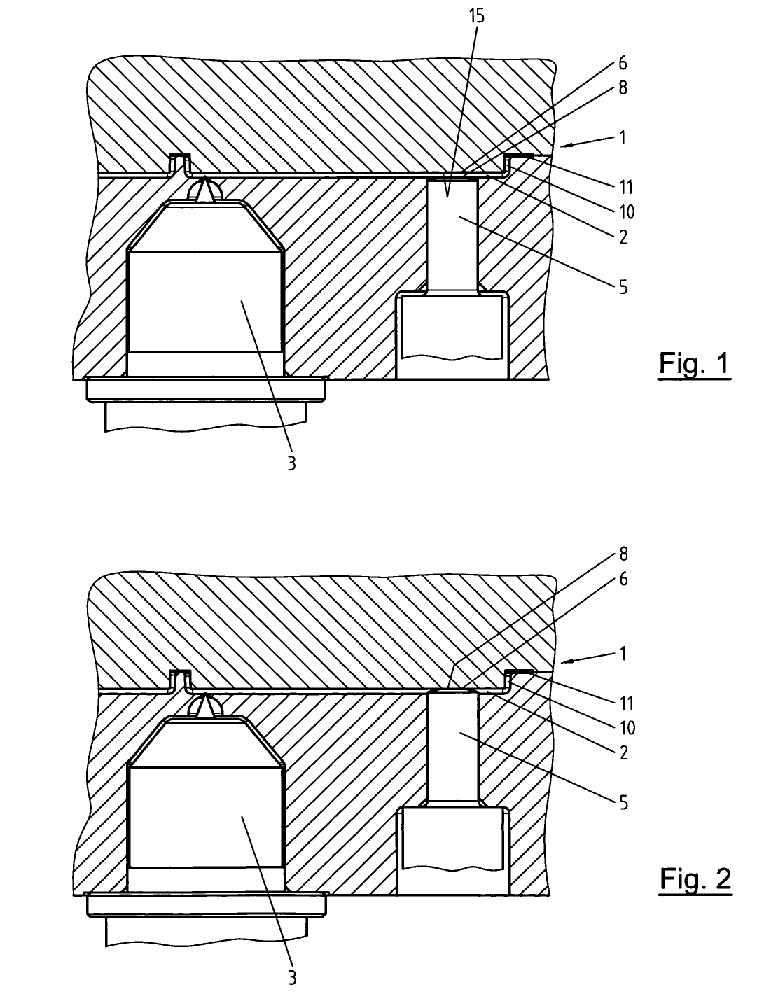

FIG. 1 shows a detail of a corresponding injection molding tool 1 with a cavity 2 and an injection nozzle 3. It further comprises a core 5 movably arranged in a recess 6 in the tool 1. The front 8 of the core 5 is slightly chamfered at its periphery in order to produce a softer transition from the thin area to the surrounding material in the final product.

In view of the preferred product, at the rim 10, a narrow circumferential cavity zone 11 is provided for producing a sealing lip. The sealing lip is shaped thinner than the main part, yet significantly thicker than the window.

FIG. 2 shows the same section as FIG. 1, however with the core 5 now moved forward to its working position. Between the front face 8 of the core 5 and the opposing area 15 of the tool remains a very narrow gap of e.g. some hundredths of a millimeter.

In all other aspects, the tool 1 is designed according to the known state of the art, and a detailed description is not necessary.

In injection molding, after closing the molding tool 1, the molding mass, e.g. high-density polyethylene (HD-PE) or polypropylene (PP), is injected by one or more nozzles 3 into the cavity 2. The mass distributes in the cavity 2 and fills it. When the cavity is about full, the pressure needed to inject the molten mass increases significantly. At this stage, the space before core 5 is filled with still fluid mass. The actuator (conventional, e.g. mechanical, pneumatic or hydraulic; not shown) of core 5 is activated by a control unit (not shown), and the core 5 is pushed forward to its working position shown in FIG. 2. The control unit by itself may be one of several types according to the state of art and technology, as is the case for the actuator for the movable shaped core, hence a detailed description is waived.

As the said space is entirely filled with the molding mass, a closed, thin wall is obtained in the resulting minute gap. It may even be supposed that due to the increased pressure exerted on the already cooling and solidifying molding mass, the strength and density of the skin-like, thin wall area obtained, is further improved by this method. Using the method according to the invention, a wall thickness of 0.03 mm can be obtained with high yield, and even 0.02 mm is feasible. In comparison, conventional injection molding allowed a minimal wall thickness of 0.15 mm, and with this value, a major part of the produced pieces were out of spec, i.e. the thin area was defective in some way.

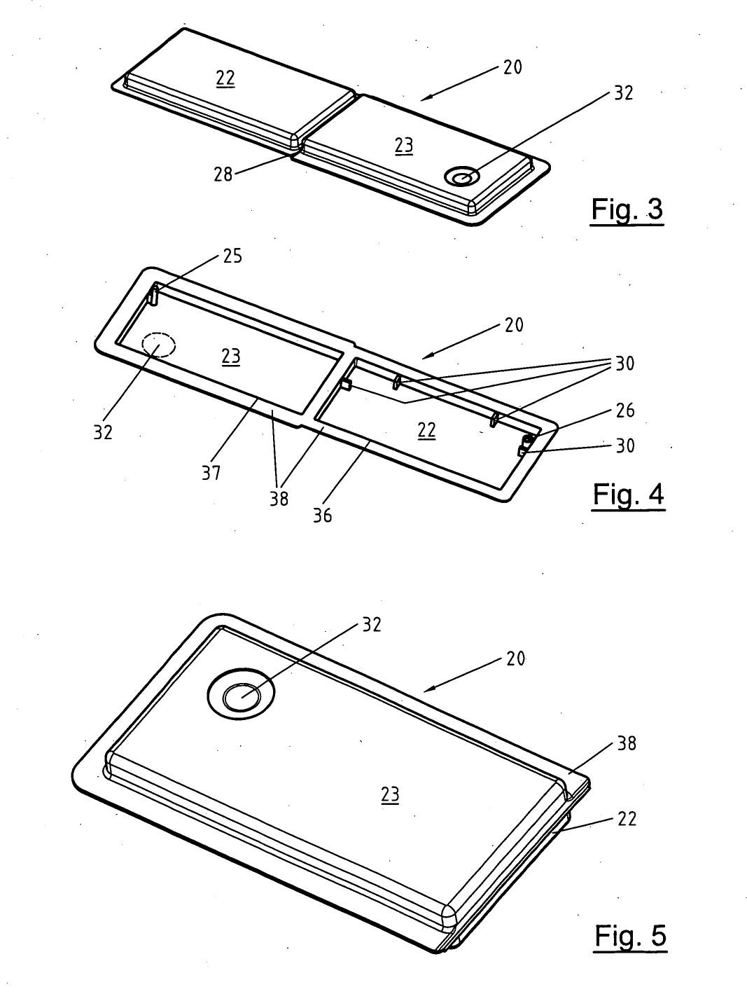

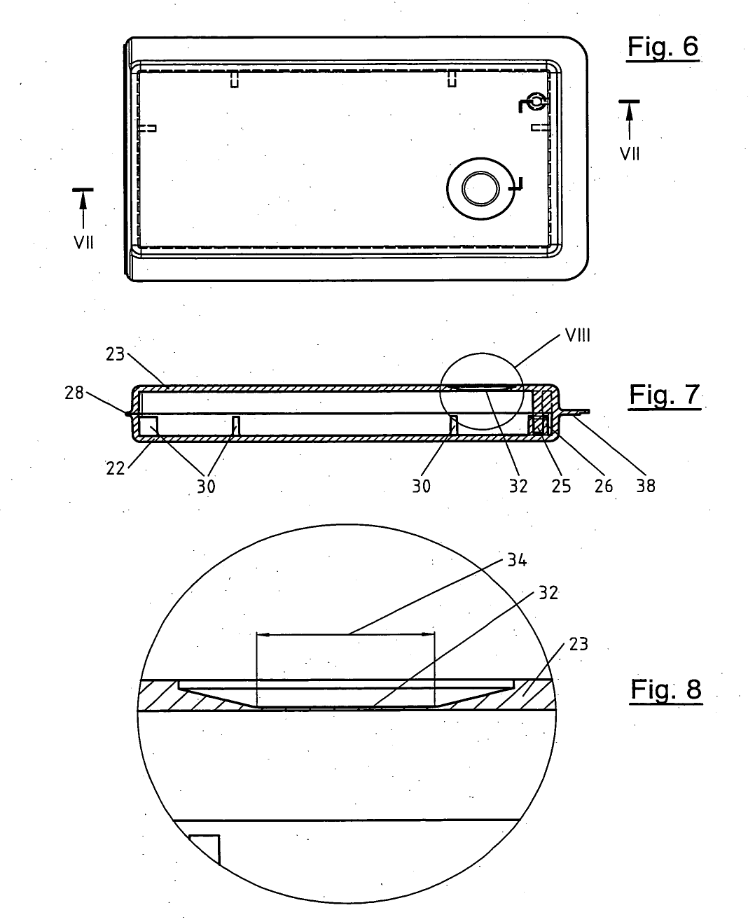

The described process is particularly suited to produce hangers 20 for dosimeters (FIGS. 3-8). The hanger 20 is injection molded as one piece in one single molding cycle. It consists of a base 22 and a cover 23. Internally, the cover 23 is provided with a positioning pin 25, and the base with a complementary positioning collet 26. For closing the housing 20, cover and base are positioned one on top of the other by bending the connecting strip 28, and the pin 25 is pushed in the collet 26.

The base 22 is further provided with positioning protrusions 30 which correspond to the shape and possibly recesses or the like in the body of a dosimeter (not shown). The protrusions 30 are arranged in such a way, that a dosimeter may be inserted in one unique and correct position only.

As already mentioned, the hanger provides a window 32 where the wall thickness of the cover 23 is reduced to some few hundredths of a millimeter, while reliably maintaining waterproofness. Only by applying the injection molding process according to the invention and the respective tool, producing this window integrally with the hanger by high yield injection molding became feasible.

The window 32 is shown enlarged in the detail section of FIG. 8. For example, with the nominal wall thickness of the cover being about 1 mm, within the window 32, the thickness may be 0.07-0.08 mm, with the diameter 34 of this area being about 4 mm.

The contact borders 36, 37 of base 22 and cover 23 are shaped as flanges, i.e. a welding lip 38 is provided at each of the rims. The welding lips are significantly thinner than the main parts of cover 23 and base 22.

When the housing 20 is closed around a dosimeter, the welding lips are welded together. Thereby, the hanger is closed in a manner that any reopening attempt destroys the hanger. Hence, the contained dosimeter cannot be exchanged inadvertently. Furthermore, applying a proper weld, the hanger is waterproof, which is highly desirable.

Regarding the material, polypropylene and polyethylene, particularly high density polyethylene, have proven to be well suited. The property of being a disposable one-way product for the hanger, is greatly outweighed by the gain in safety in the handling of the dosimeters and the reduced costs per unit.

The invention being explained by means of preferred embodiments, a person skilled in the art and the technology is capable to conceive numerous variants and modifications without leaving the scope of protection which is defined by the claims.

For example, the following alteration may be thought of: other plastic materials may be molded using the method according to the invention, or be employed as the material for the dosimeter hangers. Possibly, other materials suited to injection molding, may be thought of. Actuation of the cores may occur from simultaneously to sequentially. Another variant may be to create the narrow gap in the injection molding tool using two cores which are moved almost simultaneously into the cavity in opposite directions so that the gap is obtained between the front faces of the two cores. Thereby, e.g. a virtually symmetrical thin-walled area may be obtained.

The process and tool may be used for producing other objects by injection molding, where one or more areas of significantly reduced wall thickness, compared to neighboring areas are required.

Objects having portions thinner than 0.02 mm are also conceivable by carefully matching molding substrates and injection parameters, but best results are presently obtained by respecting the mentioned limits.

1. A method for producing thin areas in injection-molded objects, the method comprising the steps:
injecting the thermoplastic polymeric molding mass in the cavity of an injection molding tool;
pushing at least one movable core into the cavity while the molding mass is still capable of flowing, whereby the distance between a front face of the core and an opposing surface is reduced to a gap width,
in order to create an area of reduced thickness of the molded object.

2. The method of claim 1, wherein the injection pressure applied for injecting the molding mass is measured, and the movable core is pushed in when a predetermined increase of the injection pressure is observed and/or the injection pressure exceeds a predetermined value.

3. The method of claim 1, wherein the core is pushed in approximately 0.5 to 1 second after the injection of the molding mass into the cavity of the tool has begun.

4. The method of claim 1, wherein the molding mass is one of polyethylene, polypropylene.

5. The method of claim 4, wherein the molding mass is high-density polyethylene (HDPE).

6. The method of claim 1, wherein the gap width is equal to or smaller than 0.1 mm

7. The method of claim 6, wherein the gap width is equal to or smaller than 0.08 mm

8. The method of claim 6, wherein the gap width is 0.02 mm or more.

9. The method of claim 8, wherein the gap width is 0.03 mm or more.

10. The method of claim 1, wherein a second movable core, having a front face substantially opposing the front face of the movable core, is moved towards the movable core so that the gap is built substantially between the front faces of the two cores.

11. An injection molding tool comprising at least one movable core, the core being moveable into the cavity of the tool to a position where, between the front face of the core and a wall of the cavity or another core, a gap of a width of at most 0.1 mm is produced.

12. The injection molding tool of claim 11, wherein the gap width is at least 0.02 mm.

13. The injection molding tool of claim 11, wherein the gap width is at most 0.08 mm.

14. An object produced by the method of claim 1, provided with at least one thin area of reduced thickness and substantial extension where the wall thickness is at most 0.1 mm, wherein the thin area is an integral part of the surrounding portion of the object.

15. The object of claim 14, wherein the wall thickness of the thin area is at most 0.08 mm.

16. The object of claim 14, wherein the wall thickness of the thin area is at least 0.02 mm.

17. The object of claim 16, wherein the wall thickness of the thin area is at least 0.03 mm.

18. A hanger for a dosimeter with a virtual opening for providing a window of practically unrestricted by absorption passage to radiation, the hanger consisting of polymeric material, and the window being an integral part of the surrounding portion of the hanger and having a thickness less than or equal 0.1 mm

19. The housing of claim 18, wherein the window has a thickness of at least 0.02 mm.

20. The housing of claim 18, consisting of one piece.

21. The housing of claim 18, wherein the window has a thickness of about 0.07 mm to 0.08 mm.

22. The housing of claim 18, wherein the window has a thickness of at least 0.03 mm.
